(19) United States
(12) Patent Application Publication
(10) Pub. No.: US 2010/0017196 A1
(43) Pub. Date: Jan. 21, 2010

(54) METHOD, SYSTEM, AND APPARATUS FOR COMPRESSION OR DECOMPRESSION OF DIGITAL SIGNALS

(75) Inventors: Sang-Uk Ryu, San Diego, CA (US); Samir K. Gupta, San Diego, CA (US); Philip Rutschman, Seattle, WA (US); Heejong Yoo, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/504,592

(22) Filed: Jul. 16, 2009

Related U.S. Application Data
(60) Provisional application No. 61/082,170, filed on Jul. 18, 2008.
(60) Provisional application No. 61/091,263, filed on Aug. 22, 2008.

(51) Int. Cl. G10L 19/00

(52) U.S. Cl. 704/201; 704/E19.004

(57) ABSTRACT

Embodiments of methods, apparatuses, devices and systems associated with compression and decompression of digital signals are disclosed.

### RELATED APPLICATIONS

The present Application for Patent claims the benefit of Provisional Application No. 61/082,170 entitled “LOW-DELAY AND LOW-COMPLEXITY LOSSLESS CODEC FOR SIGNALS WITH SMALL DYNAMIC RANGE” filed Jul. 18, 2008, and Provisional Application No. 61/091,263 entitled “LOW-DELAY AND LOW-COMPLEXITY LOSSLESS assigned to the assignee hereof.

### FIELD

Embodiments relate to the field of encoding or decoding digital content, such as encoding or decoding audio information that is represented by digital signals, for example.

### INFORMATION

For various forms of digitized content, including digitized audio signals, for example, lossless compression and/or decompression may be desirable in a variety of circumstances. Techniques for such compression or decompression continue to be sought, particularly techniques offering low delay or low computational complexity.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a is a schematic diagram of a low-delay low-complexity lossless coding scheme, in accordance with an embodiment

FIG. 2 is a block diagram of an encoding and decoding scheme;

FIG. 3 is a block diagram of another encoding and decoding scheme;

FIG. 4 is a block diagram an encoding/decoding scheme in accordance with an embodiment;

FIG. 5 is a block diagram of one or more aspects of a variable bit-length encoding/decoding scheme in accordance with an embodiment;

FIG. 6 is a block diagram of one or more aspects of a variable bit-length encoding scheme in accordance with an embodiment; and

FIG. 7 is a block diagram of one or more aspects of a variable bit-length decoding scheme in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description presented below are presented in terms of algorithms or symbolic representations of operations on binary digital signals stored within a memory of a specific apparatus or special purpose computing device, apparatus, or platform. In the context of this particular specification, the term specific apparatus, special purpose computing device, and/or the like may includes a general purpose computer or other computing device, such as a Personal Digital Assistant, portable telephone, cellular telephone, Smart phone, or the like, once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions or processes of a specific apparatus, such as a special purpose computer, special purpose computing apparatus, or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, audio devices, or display devices of the special purpose computer or similar special purpose electronic computing device.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

For a variety of reasons, discussed more fully below, embodiments of compression or decompression schemes continue to be desirable. Under some circumstances, available audio codecs may be one or more lossy signal compression schemes which allow higher signal compression by effectively removing statistical and/or perceptual redundancies in signals. In such circumstances, decoded signals from a lossy audio compression scheme may not be substantially identical to original audio signals. For example, distortion or coding noise could be introduced during a lossy audio coding scheme or process, although, under some circumstances, such defects may be perceptually reduced, so the processed audio signals may be perceived as at least approximately close to original audio signals.

Under some circumstances, however, lossless coding may be more desirable. For example, a lossless coding scheme or process may allow an original audio signal to be reconstructed from compressed audio signals. Numerous types of lossless audio codecs such as ALAC, MPEG-4 ALS and SLS, Monkey's Audio, Shorten, FLAC, and WavPack have been developed for the compression of one or more audio signals. However, under some circumstances such lossless codecs may employ computationally expensive or complex signal processing. Such signal processing may, under some circumstances, employ relatively large amounts of memory for storing large portion of input data (e.g., 2048 PCM signal samples) and therefore may, under some circumstances, introduce a significant end-to-end latency.

One possible approach, based at least in part on one or more lossless compression schemes within the context of a G.711 standard compliant input signal, such as A-law or μ-law mappings, may be employed in voice communication, such as voice communication over an IP network. In such an application, speech signals represented by 16-bit linear Pulse Code Modulated (PCM) may be mapped to 8-bit non-linear PCM samples. Such 8-bit sample signals may be transmitted to another device or via a communication network and may be decoded by G.711 decoder to a lossy version of the original 16-bit PCM samples. Under such a circumstance, a lossless compression and decompression for 8-bit sample mapped by a G.711 encoding may be desirable for efficient usage of network bandwidth. The above mentioned lossless codecs, however, may not be desirable to be employed in this approach. For example, such lossless codecs may, under some circumstances use significant computational or memory resources. In addition, such codecs may be designed specifically for a particular range value of 16-bit PCM signal samples. Hence, a low-delay low-complexity lossless compression scheme or process may be employed for signals characterized by having a small dynamic range of values.

As used herein, the term “small dynamic range” may refer to a range of signal values, such that one or more representations of such signals values, such as from a highest signal value level to a lowest signal value level may comprise a relatively small range. Although a small dynamic range is not necessarily required to be quantified in terms of bits, nonetheless, it may not be unusual to infer from the number of bits for a binary digital signal its dynamic range. For example, one or more 8-bit signals may have a small dynamic range where all eight bits vary. Likewise, one or more signals having many more bits, such as a 64 bit binary digital signal, may still have a small dynamic range if, for example, a subset of the 64 bits at the lower end of the binary digital signal range vary while the other remaining bits of the 64 do not vary. It is noted, of course that the latter two examples are provided merely for purposes of illustration and are not intended to limit the scope of claimed subject matter in any way. Furthermore, a “signal” as used herein may refer to media signals which may correspond to particular instances or samples in time relative to a particular physical attribute or manifestation, such as, for example, without, limitation, sound, image, video, or the like.

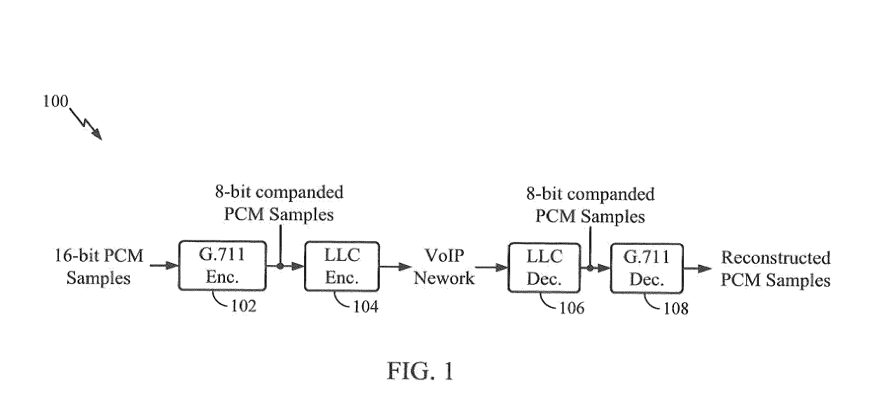

FIG. 1 shows an exemplary deployment of an embodiment of a low-delay low-complexity lossless coding scheme for a narrow dynamic range value input signal, for example, G.711 (8-bit) compliant A-law or μ-law mappings of non-linear PCM speech signals. In an embodiment, coding scheme 100 may comprise a lossless encoding or decoding scheme, at least in part, designed to be effective or efficient in terms of coding efficiency for 8-bit PCM speech samples. In an embodiment, a low-delay or low-complexity encoding scheme may have a relatively smaller number of input PCM signal samples, and may have latency and complexity that may be competitive or comparable with other lossless general audio codecs. With regard to FIG. 1, a G.711 encoding module 102 may receive one or more 16-bit PCM signal samples. G.711 encoding module 102 may be operable to modify the received 16-bit PCM signal samples at least in part to generate 8-bit non-linear PCM signal samples, such as 8-bit companded PCM signal samples compatible with the G.711 standard, for example. The generated 8-bit PCM signal samples may then be received by a lossless coding (LLC) encoder 104. In an embodiment, the losslessly encoded 8-bit PCM signals may be transmitted as a bitstream via a communication network, such as an IP network, to a LLC decoder 106. In an embodiment, LLC decoder 106 may be operable to reconstruct the 8-bit PCM signal samples from the encoded 8-bit PCM signals. The reconstructed 8-bit PCM signal samples may then be received by a G.711 decoder 108. In an embodiment, G.711 decoder 108 may be operable to reconstruct the 16-bit PCM signal samples from the reconstructed 8-bit PCM signal samples. It should, however, be noted that these are merely illustrative examples relating to a lossless encoding scheme and that claimed subject matter is not limited in this regard.

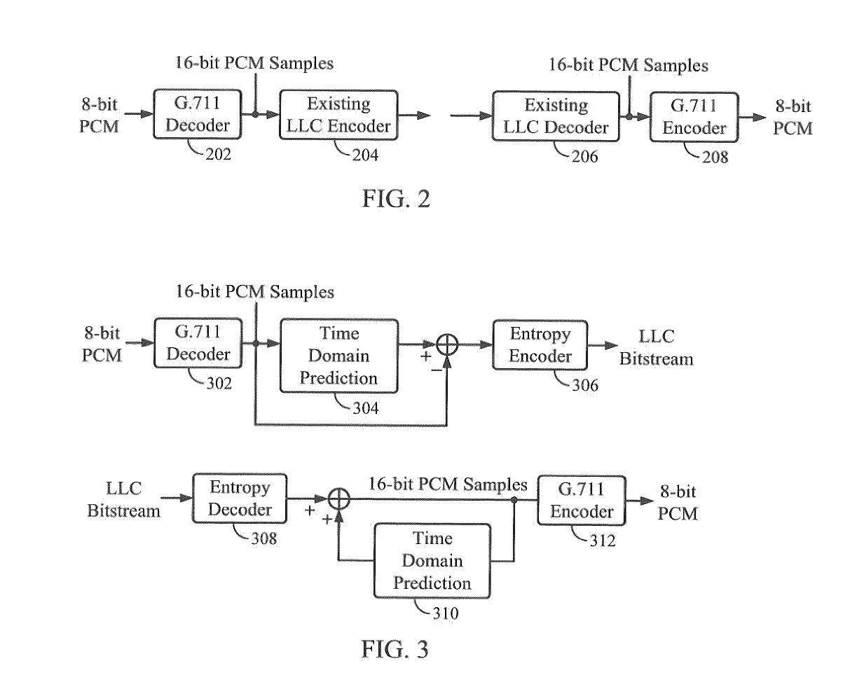

With regard to FIG. 2, an 8-bit PCM signal, such as a signal compatible with the G.711 standard may be received by a G.711 decoder 202. G.711 decoder 202 may apply one or more processes on the received 8-bit PCM signal at least in part to transform that signal into one or more 16-bit PCM signal samples. The one or more 16-bit PCM signal samples may in turn be received by an available lossless codec (LLC) encoder 204. LLC encoder 204 may in turn compress the one or more 16 bit PCM signal samples, such as with one of the encoding schemes discussed above. The encoded one or more 16-bit PCM signal samples may be transmitted to an available LLC decoder 106. In this example, LLC decoder 206 may be operable to decode the encoded one or more 16-bit PCM signal samples, at least in part to produce the original one or more 16-bit PCM signal samples. Furthermore, in this example, the decoded one or more 16-bit PCM signal samples may be received by a G.711 encoder 208. G.711 encoder 208 may operate on the decoded one or more 16-bit PCM signal samples at least in part to produce one or more 8-bit PCM signal samples, such as one or more signal samples compliant (or compatible) with the G.711 standard, for example. The produced one or more 8-bit PCM signal samples may then be transmitted to one or more portions of a device, such as a computing platform, peripheral device, or cellular phone for example, for further processing. However, under some circumstances, the above scheme may not produce desirable compression in one or more encoded signals, or may experience undesirable latency or complexity.

With regard to FIG. 3, under some circumstances, a lossless compression scheme, such as shown above with regard to FIG. 1, may further employ one or more prediction tools or modules. For example, a G.711 decoder 302 may produce one or more 16-bit PCM signal samples from one or more received 8-bit PCM signal samples. In this example, the produced one or more 16-bit PCM signal samples may be transmitted to a Time Domain Prediction Module 304. The Time Domain Prediction Module 204 may, in conjunction with an entropy encoder 306 may be operable to generate an encoded bitstream. In this example, the encoded bitstream may be transmitted to an entropy decoder 308. Entropy decoder 308 may, in conjunction with Time Domain Prediction Module 310 be operable to decode the encoded bitstream at least in part to reproduce the one or more 16-bit PCM signal samples. The decoded one or more 16-bit PCM signal samples may then be transmitted to a G.711 encoder 312 at least in part to produce one or more 8-bit PCM signal samples, such as one or more samples compliant with the G.711 standard, for example. The produced one or more 8-bit PCM signal samples may then be transmitted to one or more portions of a device, such as a computing platform, peripheral device, or cellular phone for example, for further processing. However, under some circumstances, the above scheme may not produce desirable compression in one or more encoded signals, or may experience undesirable latency or complexity.

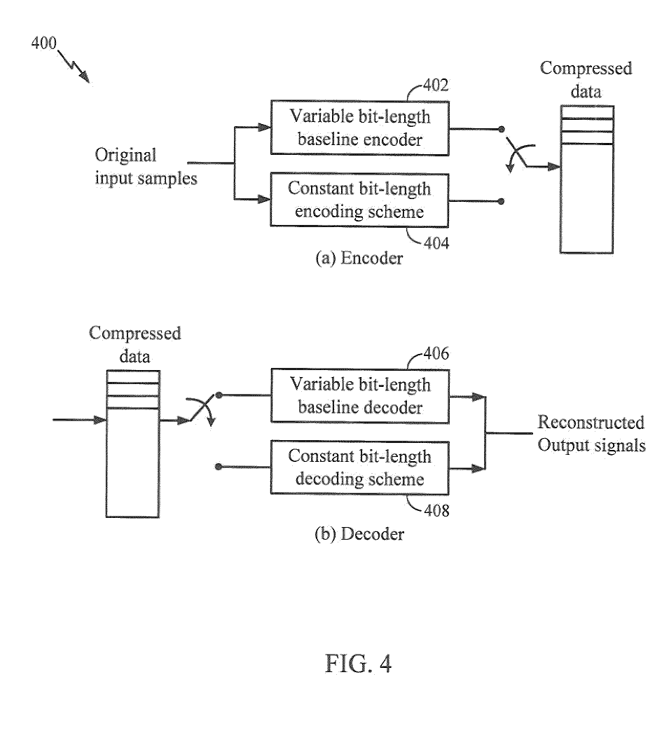

FIG. 4 shows a detailed block diagram 400 of an encoding scheme in accordance with an embodiment of LLC encoder 104 and a decoding scheme in accordance with an embodiment of LLC decoder 106 that may, under some circumstances, address one or more of the above described deficiencies. In an embodiment, an encoding scheme may comprise a variable bit-length encoder 402, at least in part for handling one or more signals, and supplemental constant bit-length encoder 404, at least in part for handling one or more special cases of signal samples for which a number of output bits generated by variable bit-length baseline encoding may become greater than a number of output bits generated by a constant bit-length coding. For respective input signal blocks, a more desirable one of variable bit-length encoder 402 and constant bit-length encoder 404 may be selected for encoding a signal block and a signaling bit may be transmitted along with encoded signal samples at least in part so that a decoder can tell which encoding scheme was used for a particular signal block. With regard to FIG. 2, an LLC decoder 406 may comprise a variable bit-length decoder 406 and a constant bit-length decoder 408 at least in part for reconstructing signal samples encoded with variable bit-length encoder 402 or constant bit-length encoder 404.

With regard to a variable bit-length baseline codec, an encoding or decoding device may implement a lossless codec that may be structured to perform the predictive coding scheme, at least in part using one or more predictors to reduce a dynamic range of one or more input signals. In an embodiment, a prediction module, at least in part for determining the one or more predicted signal values, may be implemented using one or more schemes, which may, under some circumstances, result in better prediction gain. For example, a prediction module may employ a set of fixed predictors, high-order forward predictors, adaptive backward predictors, or the like. In an embodiment, one or more differentials between the one or more predicted signal values and one or more signal actual values may be encoded at least in part using one or more variable bit-length entropy codes. In an embodiment, a differential between the one or more predicted signal values and the one or more actual signal values may be referred to as a prediction residual. In an embodiment, one or more prediction residual values may be modeled by a Laplacian distribution, and may be encoded with a variable bit-length coding scheme, such as Golomb-Rice coding, that may be desirable for that particular distribution.

Although, for the most part, described in terms small dynamic range of input signal, a lossless codec in accordance with an embodiment may also be used, such as with one or more modifications, for signals having a larger dynamic of input signal, such as by using a permutation coding scheme. For example, a permutation coding scheme as described in U.S. patent application Ser. No. 11/840,880, entitled ENCODING AND/OR DECODING DIGITAL CONTENT, may under some circumstances be employed with a lossless codec in accordance with an embodiment. Though, of course, claimed subject matter is not limited in this regard and may employ schemes other than those mentioned above.

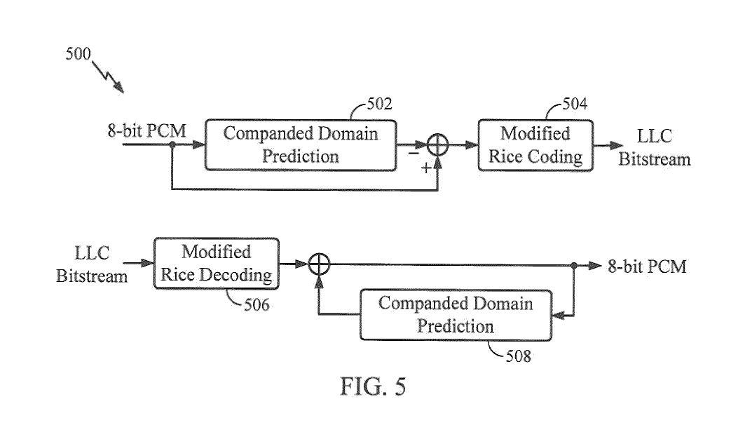

FIG. 5 is a diagram of an encoding/decoding scheme 500 in accordance with an embodiment of variable bit-length coder. The lossless codec disclosed herein may be adapted for an input signal with small dynamic range but its coding efficiency may be improved even for the input signal with wide dynamic range if a permutation coding scheme is embedded as one of the selections. The above approach could achieve better compression gain by performing differentiation in the companded domain, but could be further improved as below shown in FIG. 5. In an embodiment, a low-delay low-complexity encoding or decoding scheme or process may comprise two or more blocks or modules, such as a domain prediction module 502, such as a companded domain prediction module, for example, and a Rice coding module 504, such as a Rice coding module or a modified Rice coding module, at least in part to encode one or more signals. Likewise, encoding/decoding scheme 500 may also employ a Rice decoding module 506, such as a Rice decoding module or a modified Rice decoding module, along with a domain prediction module 508 at least in part to reconstruct the encoded one or more signals. However, it should be noted that the above example is in no way limited to a companded domain. For example, an encoding or decoding scheme in accordance with an embodiment may be used with one or more signals in a time domain as well. Accordingly, claimed subject matter should not be limited in this regard. Likewise, encoding/decoding scheme 500 may also employ a Rice decoding module 506, such as a Rice decoding module or a modified Rice decoding module, along with a domain prediction module 508 at least in part to reconstruct the one or more signals that were previously encoded. It should, however, be noted that this is merely an illustrative example relating to an encoding/decoding scheme and that claimed subject matter is not limited in this regard.

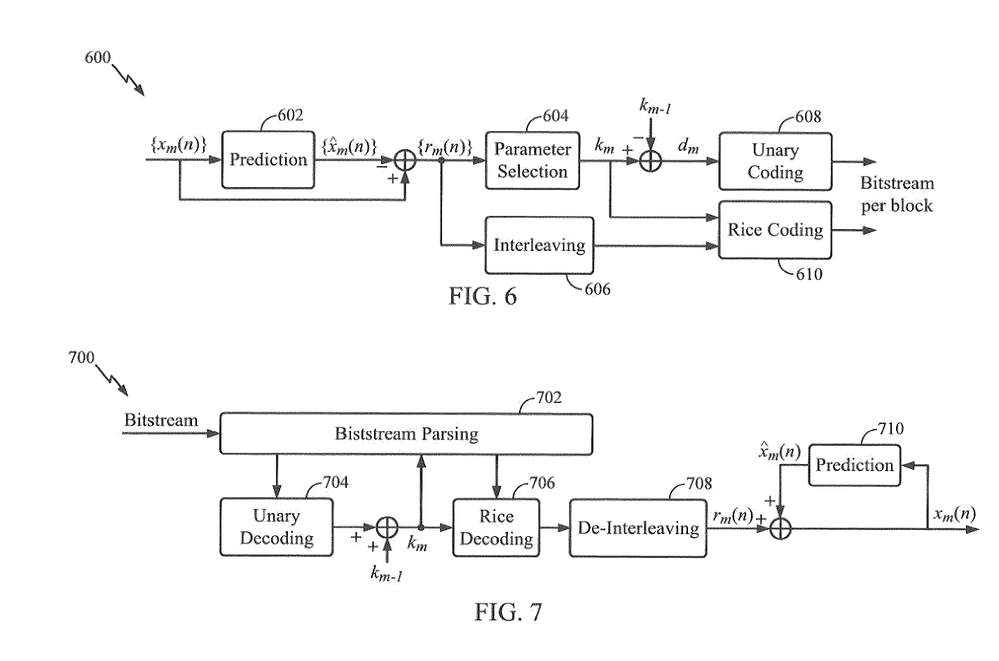

FIG. 6 shows a block diagram of an encoding scheme 600 of variable bit-length encoder in accordance with an embodiment, such as the encoding scheme shown in FIG. 5. In an embodiment, a prediction module 602 may be implemented in many different forms including advanced schemes for better prediction gain, such as, for example, a set of fixed predictors, high-order forward predictors, adaptive backward predictors, and so on. In at least one embodiment, efficient schemes for linear prediction and entropy coding of prediction residuals may be employed at least in part to reduce an implementational complexity or algorithmic delay of an encoding scheme. For example, one may employ a simple first-order linear predictor that predicts a current signal sample by a previous signal sample. In an embodiment, a computationally efficient entropy coding scheme may be employed at least in part to encode a differential between a predicted signal value and an actual signal value, such as a residual signal value. In an embodiment, encoding scheme 600 may further comprise a selection module 604, an interleaving module 606 a unary coding module 608 and a Rice coding module 610. However, it should be noted that interleaving module 606 may, under some circumstances be options. For example, rather than employing an interleaving module, an embodiment may instead employ a sign bit to at least in part indicate if one or more values have negative values. Accordingly, claimed subject matter should not be limited in this regard. In at least one embodiment, an interleaved residual signal value may be encoded using one or more Rice coding schemes. In an embodiment, Rice coding may be considered as a specialized Golomb coding for the case where code parameter is a power of 2, so one may perform operations employed in Rice coding with a number of additions and bit shifts.

In an embodiment of an encoding scheme an input signal x(n) may be partitioned into consecutive N-signal sample blocks, and M number of blocks comprise a signal frame, i.e., a frame contains MN input signal samples, of course, claimed subject matter is not limited in this regard. Denoting the n-th signal sample in the m-th block of a signal frame as xₘ(n) for 0≦n<N and 0≦m<M, the prediction of the current signal sample may be expressed as

$${\hat{x}}_{m} ( n ) = \{ \begin{matrix}0 , & n = 0 , m = 0 , \\ {x}_{m - 1} ( N - 1 ) , & n = 0 , m \geq 1 , \\ {x}_{m} ( n - 1 ) , & n \geq 1.\end{matrix}$$

Within a block, a previous signal sample may be used as a predicted signal value of a current signal sample. However, under some circumstances, such as at a boundary between one or more blocks, the last signal sample in the previous signal block may serve as a prediction of a first signal sample of a current signal block. Under some circumstances, such as for a first signal sample in the first signal block, no prediction is employed to avoid frame level decoding dependency. For example, it may, under some circumstances be desirable for separate frames of signals to not be dependent upon one another. Accordingly, it may under some circumstances, be desirable for a first signal sample of a frame not to be encoded based on any prior signal samples. In an embodiment, a prediction residual signal may be computed as follows:

$${r}_{m} ( n ) = \{ \begin{matrix}{x}_{0} ( 0 ) , & n = 0 , m = 0 , \\ {x}_{m} ( 0 ) - {x}_{m - 1} ( N - 1 ) , & n = 0 , m \geq 1 , \\ {x}_{m} ( n ) - {x}_{m} ( n - 1 ) , & n \geq 1.\end{matrix}$$

Once an N-sample block of prediction residual signal is determined, such prediction residual signal samples may be interleaved in an interleaving block 506 in FIG. 6 to non-negative values as:

$${r}_{m}^{+} ( n ) = \{ \begin{matrix}2 {r}_{m} ( n ) , & if {r}_{m} ( n ) \geq 0 \\ - 2 {r}_{m} ( n ) - 1 , & if {r}_{m} ( n ) < 0.\end{matrix}$$

The interleaved samples of prediction residual signals may be operated on by a Rice coding process. Such a Rice coding process for a non-negative integer n may include at least one or more of coding elements: unary coding of a quotient └n/2^{k}┘ and constant bit-length coding of k LS bits of a remainder. For example of n=11 (‘1011’), Rice coding with k=2 yields a codeword ‘00111’: unary coding of quotient 2 (‘001’) and 2-bit coding for remainder 3 (‘11’). If a Rice coding parameter is selected as k=1, the integer 11 may be coded in this case as a 7-bit codeword ‘0000011’. From this example, it could be seen that (i) Rice coding of non-negative integer n with parameter k yields └n/2^{k}┘+k+1 bits, and (ii) for a given non-negative integer or a set of non-negative integers, there should be a desirable Rice parameter that produces a smallest number of bits. Given N-sample block of the interleaved values of prediction residual signal, a parameter selection block 604 in FIG. 6 determines a desirable Rice coding parameter such that

$${k}_{m} = ⌊ {log}_{2} {μ}_{m} + 0.97 ⌋ , \\ where$$

$${μ}_{m} = \frac{1}{N} {\sum }_{n = 0}^{N - 1} \vert {r}_{m} ( n ) \vert .$$

Once a desirable Rice parameter kₘ is determined, such as by a selection module 604, the kₘ may be differentiated from a Rice parameter of the previous block kₘ₋₁, and the resulting differential may be interleaved to a non-negative value and then be unary-encoded, such as by unary coding module 608, for example. In order to avoid dependency in decoding a Rice parameter, the parameter value of the first block in a frame may be unary-encoded without differential coding from the parameter of the last block of the previous frame. The prediction residual signals are then Rice-coded with the desired Rice kₘ, such as by Rice coding module 610, for example.

For Rice coding of interleaved samples of prediction residuals, such samples may be decomposed into respective quotient and remainder values. In an embodiment, quotient and remainder values may be computed by down-shifting the interleaved sample by kₘ bits and by taking the LS kₘ bits of the interleaved sample, respectively. Then, the quotient and remainder may be respectively encoded via unary coding and constant-bit coding of kₘ LS bits, and their codewords may be packed into a bitstream. After encoding all M blocks, a number of zeros may be inserted at the end of the coded bitstream to make it byte-aligned.

FIG. 7 is a block diagram of a decoding scheme 700 of variable bit-length decoder in accordance with an embodiment, such as the decoding scheme shown in FIG. 5. In an embodiment, a decoder module for a low-delay low-complexity decoding scheme may reverse one or more operations of the above-described encoding processes for given bitstream. In the beginning of bitstream, a unary codeword of a Rice parameter for the first block may be parsed, such as by bitstream parsing module 702 and be decoded, such as by unary decoding module 704, with which codewords for interleaved samples of prediction residual in the first block are sequentially parsed and Rice-decoded, such as by Rice decoding module 706. After Rice-decoding, the interleaved samples of prediction residual may be de-interleaved, such as by de-interleaving module 708 to integer values of prediction residual. Adding prediction residual samples with predicted samples by prediction module 710, one may losslessly reconstruct the original input signal samples in the block. One or more of the above processes are repeated for one or more remaining blocks of encoded signal samples. However, the process for decoding of a Rice parameter and a first residual signal value of a block which relies on a previous block may or may not be employed for one or more of the remaining blocks.

Although the above discussed encoding and decoding schemes may be effective for handling many signals with small dynamic range such as, G.711 PCM compliant speech signal samples, such as A-law or μ-law mappings, there may be some corner cases in which a specialized constant bit-length coding can yield better compression gain than the variable bit-length baseline codec. For example, if a speaker during voice communication over IP network puts the phone in mute mode, speech signal of IP packets may contain only zero or constant-valued signal samples. For such blocks, it may be more cost-effective to signal such cases to decoder with a few number of flag bits, rather than spending more bits by the above mentioned variable bit-length baseline codec. Another instance in which special handling may be desirable may include a sample block for which the lossless compression yields more bits than spending a constant bit for the signal samples in the block. In this case, it appears to be advantageous to encode such signal samples with constant-bit codewords along with smaller bit signaling, for example a 3-bit signaling for an 8-bit precision data and a 4-bit signaling for an 16-bit precision data, that informs the decoder how many bits are used to represent signal samples in the block. It thus could be beneficial to complement the encoding and decoding schemes with a constant bit-length compression scheme which is designed to handle special corner cases. Hence, a switching process may be introduced in the encoder, where for each block the expected numbers of output bits by the variable bit-length coding and by the constant bit-length coding may be respectively computed. The number of bits for constant bit-length coding, for instance, may be computed by the following:
(i) Interleave input signal samples in a block to non-negative values such as

$${y}_{m} ( n ) = \{ \begin{matrix}2 {x}_{m} ( n ) , & if {x}_{m} ( n ) \geq 0 \\ - 2 {x}_{m} ( n ) - 1 , & if {x}_{m} ( n ) < 0 ,\end{matrix}$$

(ii) Find a maximum signal sample

yₘₐₓ=max{yₘ(0),yₘ(1), . . . ,yₘ(N−1)},
(iii) Compute the number of bits to represent input samples in a block as

└log₂(yₘₐₓ)┘+1.
Then, the total number of bits for constant-bit compression scheme can be given as 3+N(└log₂(yₘₐₓ)┘+1).

After computing the expected numbers of output bits, a switching flag is set to ‘1’ if the constant bit-length coding turns out to spend less bits than the variable bit-length baseline codec. Otherwise, the flag is set to ‘0.’ The flag bit is then inserted in the beginning of bitstream for a block, and the corresponding coding scheme starts encoding and packs the coded bits into bitstream. On the decoder side, this flag is parsed prior to actual signal sample decoding, and proper decoding procedure as is indicated by this flag will perform bitstream decoding.

The above addition may then selectively choose a better encoding scheme between variable bit-length baseline codec and constant bit-length compression scheme for a block. Special care should be taken for transition from one method to the other. Suppose that the m-th block in a signal frame is selected to be encoded by the variable bit-length baseline codec, but the previous block was encoded by constant bit-length coding. Then the Rice parameter of the current block may not be encoded differentially from the previous one, because the Rice parameter was not computed in the previous block. In such cases, the Rice parameter of a current frame itself, instead of the difference from the Rice parameter of previous frame, is encoded, which may degrade coding efficiency of the baseline codec. One efficient way to avoid this problem is to compute the Rice parameter for every block and store it for differential encoding of the signal value of the next block. Under some circumstances such a situation may not cause difficulty on an encoder side, because for a block the signal value may be computed in finding out which method produces fewer bits. On the decoder side, however, extra computations may be expended to make the Rice parameter available for decoding of the next block, even though the block was encoded by the constant bit-length compression scheme. By incorporating such a closed-loop decoding of the Rice parameter that mimics what is performed in the encoder, a relatively seamless transition between two different coding schemes for improved coding efficiency is achieved.

Likewise, the terms, “and,” “or,” and “and/or” as used herein may include a variety of meanings that will depend at least in part upon the context in which it is used. Typically, “and/or” if used to associate a list, such as A, B and/or C, is intended to mean A, B, or C as well as A, B and C. Though, it should be noted that this is merely an illustrative example and claimed subject matter is not limited to this example.

It should be noted that, although aspects of the above system, method, or process have been described in a particular order, the specific order is merely an example of a process and claimed subject matter is of course not limited to the order described. It should also be noted that the systems, methods, and processes described herein, may be capable of being performed by one or more computing platforms or computing devices. In addition, the methods or processes described herein may be capable of being stored on a storage medium as one or more machine readable instructions, that if executed may enable a computing platform, computing device, or specific purpose computing device to perform one or more actions. “Storage medium” as referred to herein relates to media capable of storing information or instructions which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. For further example, one or more computing platforms may be adapted to perform one or more of the processed or methods in accordance with claimed subject matter, such as the methods or processes described herein. However, these are merely examples relating to a storage medium and a computing platform and claimed subject matter is not limited in these respects.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
with an encoding device, compressing a narrow dynamic range binary digital signal, at least in part through signal prediction in a non-linear domain of said narrow dynamic range binary digital signal.

2. The method of claim 1, wherein said non-linear domain comprises a companded domain to which a broader dynamic range signal has been mapped.

3. The method of claim 2, and further comprising, prior to said compressing, mapping said broader dynamic range signal into said narrow dynamic range binary digital signal in said companded domain through at least one of an A-law or a μ-law mapping.

4. The method of claim 3, wherein said mapping through at least one of an A-law or a μ-law mapping comprises a mapping that is substantially in compliance, or compatible, with at least one version of the G.711 standard.

5. The method of claim 1, wherein said prediction in a non-linear domain of said narrow dynamic range binary digital signal comprises employing a previous signal value as a prediction of a current signal value.

6. The method of claim 1, wherein said narrow dynamic range binary digital signal comprises a digitized audio signal.

7. The method of claim 6, wherein said digitized audio signal comprises a digitized signal of human speech.

8. The method of claim 7, wherein said digitized signal of human speech comprises an 8-bit digitized signal of human speech.

9. An apparatus comprising:
an encoding device; and
said encoding device adapted to compress a narrow dynamic range binary digital signal through signal prediction in a non-linear domain of said narrow dynamic range binary digital signal.

10. The apparatus of claim 9, wherein said non-linear domain comprises a companded domain to which a broader dynamic range signal has been mapped.

11. The apparatus of claim 10, wherein said encoding device is further adapted to, prior to the compression, map said broader dynamic range signal into said narrow dynamic range binary digital signal in said companded domain through at least one of an A-law or a μ-law mapping.

12. The apparatus of claim 11, wherein the mapping through at least one of an A-law or a μ-law mapping comprises a mapping that is substantially in compliance, or compatible, with at least one version of the G.711 standard.

13. The apparatus of claim 9, wherein said prediction in a non-linear domain of said narrow dynamic range binary digital signal comprises employing a previous signal value as a prediction of a current signal value.

14. The apparatus of claim 9, wherein said narrow dynamic range signal comprises a digitized audio signal.

15. The apparatus of claim 14, wherein said digitized audio signal comprises a digitized signal of human speech.

16. The apparatus of claim 15, wherein said digitized signal of human speech comprises an 8-bit digitized signal of human speech.

17. An article comprising:
a storage medium having instructions stored thereon, wherein said instructions, if executed by a special purpose computing device, enable said special purpose computing device to:
compress a narrow dynamic range binary digital signal through signal prediction in a non-linear domain of said narrow dynamic range binary digital signal.

18. The article of claim 17, wherein said non-linear domain comprises a companded domain to which a broader dynamic range signal has been mapped.

19. The article of claim 18, wherein said instructions, if executed by said special purpose computing device, further enable said special purpose computing device, prior to the compression, to map said broader dynamic range signal into said narrow dynamic range binary digital signal in said companded domain through at least one of an A-law and/or a μ-law mapping.

20. The article of claim 19, wherein said instructions, if executed by said special purpose computing device, further enable said special purpose computing device, prior to the compression, to map said broader dynamic range signal into said narrow dynamic range binary digital signal in said companded domain through at least one of an A-law and/or a μ-law mapping that is substantially in compliance, or compatible, with at least one version the G.711 standard.

21. The article of claim 17, wherein said instructions, if executed by said special purpose computing device, further enable said computing platform, to employ a previous signal value as a prediction of a current signal value.

22. The article of claim 17, wherein said narrow dynamic range signal comprises a digitized audio signal.

23. The article of claim 22, wherein said digitized audio signal comprises a digitized signal of human speech.

24. The article of claim 23, wherein said digitized signal of human speech comprises an 8-bit digitized signal of human speech.

25. A method comprising:
with an encoding device, comparing a narrow dynamic range binary digital signal and a predicted narrow dynamic range binary digital signal to produce a residual binary digital signal to be encoded using a Rice coding scheme.

26. The method of claim 25, wherein said Rice coding scheme comprises a Rice coding scheme and employs coding a sign bit, a quotient signal value and a remainder signal value for a given residual binary digital signal; and wherein, a zero residual signal value is coded without coding a sign bit.

27. The method of claim 25, said Rice coding scheme employs coding one or more quotient signal values and one or more remainder signal values for one or more interleaved residual binary digital signals.

28. The method of claim 25, wherein said predicted narrow dynamic range binary digital signal comprises applying a single time delay operation to an actual narrow dynamic range binary digital signal; said Rice coding scheme comprising encoding a sign bit, a quotient signal value and a remainder signal value.

29. The method of claim 28, wherein said sign coding, quotient signal value coding and remainder coding are organized in a particular bit stream so that sign, quotient and remainder encoded signal values are grouped together.

30. The method of claim 25, wherein said sign coding, quotient signal value coding, and remainder signal value coding are organized into one or more bit streams.

31. The method of claim 25, and further comprising:
encoding a first K signal value;
calculating a K signal differential between said first K signal value and a second K signal value; and
encoding said K signal differential.

32. The method of claim 31, wherein said first K signal value corresponds to a narrow dynamic range binary digital signal in a first block and said second K signal value corresponds to a narrow dynamic range binary digital signal in a second block.

33. The method of claim 25, and further comprising:
if said Rice coding scheme does not compress a block of residual binary digital signals, encoding a signal bit at least in part to indicate that said block of residual binary digital signals have not been encoded with said Rice coding scheme.

34. The method of claim 33, and further comprising encoding a subsequent block of residual binary digital signals using said Rice coding scheme.

35. The method of claim 34, and further comprising:
encoding a K signal value for said subsequent block of residual binary digital signals based at least in part on a differential between said K signal value and a K signal value corresponding to the block of residual binary digital signals that were not encoded with said Rice coding scheme.

36. The method of claim 25, and further comprising:
organizing a group of narrow dynamic range binary digital signals into one or more frames.

37. The method of claim 36, wherein said one or more frames are encoded at least in part independently of one another.

38. An apparatus comprising:
an encoding device: and
said encoding device adapted to compare a narrow dynamic range binary digital signal and a predicted narrow dynamic range binary digital signal to produce a residual binary digital signal to be encoded using a Rice coding scheme.

39. The apparatus of claim 38, wherein said Rice coding scheme comprises a Rice coding scheme and employs coding a sign bit, a quotient signal value and a remainder signal value for a given residual binary digital signal; wherein, a zero residual signal value is coded without coding a sign bit.

40. The apparatus of claim 38, wherein said Rice coding scheme employs coding one or more quotient signal values and one or more remainder signal values for one or more interleaved residual binary digital signals.

41. The apparatus of claim 38, wherein said predicted narrow dynamic range binary digital signal comprises applying a single time delay operation to an actual narrow dynamic range binary digital signal; said Rice coding scheme comprising coding a sign bit, a quotient signal value and a remainder signal value.

42. The apparatus of claim 41, wherein said sign coding, quotient signal value coding and remainder signal value coding are organized in a particular bit stream so that sign, quotient and remainder encoded signal values are grouped together.

43. The apparatus of claim 38, wherein said sign coding, quotient signal value coding, and remainder signal value coding are organized into one or more bit streams.

44. The apparatus of claim 38, wherein said encoding device is further adapted to encode a first K signal value, calculate a K differential between said first K signal value and a second K signal value, and encode said K signal differential.

45. The apparatus of claim 44, wherein said first K signal value corresponds to a narrow dynamic range binary digital signal in a first block and said second K signal value corresponds to a narrow dynamic range binary digital signal in a second block.

46. The apparatus of claim 38, wherein said encoding device is further adapted to encode a signal bit at least in part to indicate that a block of residual binary digital signals have not been encoded with said Rice coding scheme if said Rice coding scheme does not compress said block of residual binary digital signals.

47. The apparatus of claim 46, wherein said encoding device is further adapted to encode a subsequent block of residual binary digital signals using said Rice coding scheme.

48. The apparatus of claim 47, wherein said encoding device is further adapted to encode a K signal value for said subsequent block of residual binary digital signals based at least in part on a differential between said K signal value and a K signal value corresponding to the block of residual binary digital signals that were not encoded with said Rice coding scheme.

49. The apparatus of claim 38, wherein said encoding device is further adapted to organize a group of narrow dynamic range binary digital signals into one or more frames.

50. The apparatus of claim 49, wherein said one or more frames are encoded at least in part independently of one another.

51. An article comprising:
a storage medium having instructions stored thereon, wherein said instructions, if executed by a special purpose computing device, enable said special purpose computing device to:
compare a narrow dynamic range binary digital signal and a predicted narrow dynamic range binary digital signal to produce a residual binary digital signal to be encoded using a Rice coding scheme.

52. The article of claim 51, wherein said instructions, if executed by said special purpose computing device, further enable said special purpose computing device to employ a coding a sign bit, a quotient signal value and a remainder signal value for a given residual binary digital signal; wherein, a zero residual signal value is coded without coding a sign bit.

53. The article of claim 51, wherein said instructions, if executed by said special purpose computing device, further enable said special purpose computing device to employ coding one or more quotient signal values and one or more remainder signal values for one or more interleaved residual binary digital signals.

54. The article of claim 51, wherein said instructions, if executed by said special purpose computing device, further enable said special purpose computing device to apply a single time delay operation to an actual narrow dynamic range binary digital signal; and wherein said Rice coding scheme comprising coding a sign bit, a quotient signal value and a remainder signal value.

55. The article of claim 54, wherein said instructions, if executed by said special purpose computing device, further enable said special purpose computing device to organize said sign coding, quotient signal value coding and remainder signal value coding in a particular bit stream so that sign, quotient and remainder encoded signal values are grouped together.

56. The article of claim 51, wherein said instructions, if executed by said special purpose computing device, further enable said special purpose computing device to organize said sign coding, quotient signal value coding, and remainder signal value coding into one or more bit streams.

57. The article of claim 51, wherein said instructions, if executed by said special purpose computing device, further enable said special purpose computing device to encode a first K signal value, calculate a K signal differential between said first K signal value and a second K signal value, and encode said K signal differential.

58. The article of claim 57, wherein said first K signal value corresponds to a narrow dynamic range binary digital signal in a first block and said second K signal value corresponds to a narrow dynamic range binary digital signal in a second block.

59. The article of claim 51, wherein said instructions, if executed by said special purpose computing device, further enable said special purpose computing device to encode a signal bit at least in part to indicate that a block of residual binary digital signals have not been encoded with said Rice coding scheme if said Rice coding scheme does not compress said block of residual binary digital signals.

60. The article of claim 59, wherein said instructions, if executed by said special purpose computing device, further enable said special purpose computing device to encode a subsequent block of residual binary digital signals using said Rice coding scheme.

61. The article of claim 60, wherein said instructions, if executed by said special purpose computing device, further enable said special purpose computing device to encode a K signal value for said subsequent block of residual binary digital signals based at least in part on a differential between said K signal value and a K signal value corresponding to the block of residual binary digital signals that were not encoded with said Rice coding scheme.

62. The article of claim 51, wherein said instructions, if executed by said special purpose computing device, further enable said special purpose computing device to organize a group of narrow dynamic range binary digital signals into one or more frames.

63. The article of claim 62, wherein said one or more frames are encoded at least in part independently of one another.

64. An apparatus comprising:
means for mapping a broader dynamic range signal into a narrow dynamic range binary digital signal in said companded domain through at least one of an A-law or a μ-law mapping; and
means for compressing said narrow dynamic range binary digital signal through signal prediction in a non-linear domain of said narrow dynamic range binary digital signal.

65. An apparatus comprising:
means for comparing a narrow dynamic range binary digital signal and a predicted narrow dynamic range binary digital signal to produce a residual binary digital signal to be encoded using a Rice coding scheme; and
means for Rice coding said residual binary digital signal.

66. The apparatus of claim 65, and further comprising:
means for encoding a first K signal value;
means for calculating a K signal differential between said first K signal value and a second K signal value; and
means for encoding said K signal differential.

67. The apparatus of claim 65, and further comprising:
means for encoding a signal bit at least in part to indicate that said block of residual binary digital signals have not been encoded with said Rice coding scheme if said Rice coding scheme does not compress a block of residual binary digital signals.

68. The apparatus of claim 67, and further comprising: means for encoding a subsequent block of residual binary digital signals using said Rice coding scheme.

69. The apparatus of claim 68, and further comprising:
means for encoding a K signal value for said subsequent block of residual binary digital signals based at least in part on a differential between said K signal value and a K signal value corresponding to the block of residual binary digital signals that were not encoded with said Rice coding scheme.

70. The apparatus of claim 65, and further comprising:
means for organizing a group of narrow dynamic range binary digital signals into one or more frames.
